(19) United States
(12) Patent Application Publication
(10) Pub. No.: US 2012/0324901 A1
(43) Pub. Date: Dec. 27, 2012

(54) TANDEM FAN-TURBINE ROTOR FOR A TIP TURBINE ENGINE

(75) Inventor: Mahdy A. Allam, Glastonbury, CT (US)

(73) Assignee: UNITED TECHNOLOGIES CORPORATION, Hartford, CT (US)

(21) Appl. No.: 13/167,100

(22) Filed: Jun. 23, 2011

(51) Int. Cl. F02C 1/00; F02C 3/04; F01D 1/02

(52) U.S. Cl. 60/772; 415/68; 60/805

(57) ABSTRACT

A tandem fan-turbine rotor assembly for a tip turbine engine includes a hollow fan blade rotor and a solid fan blade rotor. The hollow fan blade rotor includes a first fan blade rotor hub, hollow fan blades, and an inducer. The solid fan blade rotor includes a second fan blade rotor hub, solid fan blades, an exo-ring, and tip turbine blades. The exo-ring connects the solid fan blades at their maximum outward radial extent. The tip turbine blades are connected to the exo-ring and extend radially outward from the exo-ring. The hollow fan blade rotor and the solid fan blade rotor rigidly attach to each other at the first and second fan blade rotor hubs.

### BACKGROUND

The present invention relates to a turbine engine. In particular, the invention relates to a fan-turbine rotor assembly for a tip turbine engine.

Conventional aircraft gas turbine engines include a forward bypass fan, a compressor, a combustor, and a turbine in sequential alignment along a single axis. The compressor provides pressurized air to the combustor, where the pressurized air is mixed with fuel and ignited to produce a high temperature, high velocity gas flow. The high temperature, high velocity gas flow impinges on turbine blades causing rotation of the turbine. Through its axial connection (either directly or through a gear box), the turbine drives the compressor and the forward fan. The rotating forward fan generates thrust through an axial bypass flow region to propel the aircraft. This conventional arrangement is very efficient in generating thrust, but the axial arrangement leads to an elongated engine shape that may not be suitable for some applications.

A more compact alternative to the conventional gas turbine engine is a tip turbine engine as disclosed in U.S. Pat. Nos. 7,845,157; 7,887,296, and 7,874,802. A tip turbine engine features fan blades located aft of a compressor, each fan blade having an internal passage that redirects pressurized air from the compressor from an axial direction to a radial direction. In doing so, the fan blades also function as a centrifugal compressor, radially accelerating and increasing the pressure of the pressurized air received from the axial compressor. The radially accelerated compressed air exits the fan blade in a forward direction and flows into a combustor positioned radially outward from the compressor. In the combustor, pressurized air is mixed with fuel and ignited to produce a high temperature, high velocity gas flow in an aft direction to impinge on turbine blades that are integrated into the tips of the fan blades, thus causing rotation of the fan blades to generate engine thrust. In addition to providing the thrust generated by the engine, the fan blades also drive the compressor, either directly or through a gear box. The result is a highly efficient gas turbine engine that is significantly shorter than a conventional gas turbine engine.

While tip turbine engines are efficient both dimensionally and in their thrust-to-weight ratio, their compact design exposes components to extreme physical loads and temperature gradients. This is particularly true of the unique hollow fan-turbine blades as they serve in their dual roles as fan blades and turbine blades.

### SUMMARY

An embodiment of the present invention is a tandem fan-turbine rotor assembly for a tip turbine engine. The rotor assembly includes a hollow fan blade rotor and a solid fan blade rotor. The hollow fan blade rotor includes a first fan blade rotor hub, hollow fan blades, and an inducer. The hollow fan blades are attached to the first fan blade rotor hub and extend radially outward from the first fan blade rotor hub. Each of the hollow fan blades includes an internal cavity extending the length of the hollow fan blade. The inducer is attached to the first fan blade rotor hub for directing air from an axial compressor to the internal cavities of the hollow fan blades. The solid fan blade rotor includes a second fan blade rotor hub, solid fan blades, an exo-ring, and tip turbine blades. The solid fan blades are attached to the second fan blade rotor hub and extend radially outward from the second fan blade rotor hub. The exo-ring connects the solid fan blades at their maximum outward radial extent. The tip turbine blades are connected to the exo-ring and extend radially outward from the exo-ring. The hollow fan blade rotor and the solid fan blade rotor rigidly attach to each other at the first and second fan blade rotor hubs.

### BRIEF DESCRIPTION OF THE DRAWINGS

FIG. 1 is a sectional view of a tip turbine engine illustrating an embodiment of a tandem fan-turbine rotor assembly of the present invention.

FIG. 2 is a sectional view of an embodiment of a tandem fan-turbine rotor assembly of the present invention.

### DETAILED DESCRIPTION

The present invention is a tandem fan-turbine rotor assembly for use with a tip turbine engine. In contrast to a conventional hollow fan-turbine blade rotor, the tandem fan-turbine rotor assembly has two fan blade rotors configured in tandem: a hollow fan blade rotor and a solid fan blade rotor. As with a conventional hollow fan-turbine rotor, the hollow fan blade rotor acts as a centrifugal compressor, directing and further compressing a flow of compressed air from an axial compressor to a combustor located radially outward from the axial compressor. However, in contrast to the conventional design, the combustion gases generated by the combustor impinge on tip turbine blades attached not to a hollow fan blade rotor, but to a solid fan blade rotor. Forces generated on the tip turbine blades cause rotation of the solid fan blade rotor. The rotating solid fan blade rotor cause tandem rotation of the hollow fan blade rotor through a direct connection at the rotor hubs, thereby generating forward engine thrust. The solid fan blade rotor also causes rotation of the axial compressor through a gearbox connection. By splitting the functions of a conventional hollow fan-turbine blade rotor between two fan blade rotors configured as a tandem fan-turbine rotor assembly, the extreme physical loads and temperature gradients can be limited to the solid fan blade rotor. Without the need for an internal cavity, the solid fan blade rotor can be manufactured with techniques, such as forging, that produce superior strength and durability, rather than techniques necessary for complex, hollow shapes, such as casting, that do not produce the desired strength and durability. In addition, because the hollow fan blade rotor no longer carries the tip turbine blades, a hollow component (exducer) at the tip of the hollow fan blades can be isolated from the very hot combustion gas flow by an air gap. The air gap separation greatly reduces the temperature gradient across the exducer, simplifying its design and extending its lifespan. Finally, by carrying the bulk of the mechanical stress load in the durable solid fan blade, the lifespan of the hollow fan blades is also greatly extended.

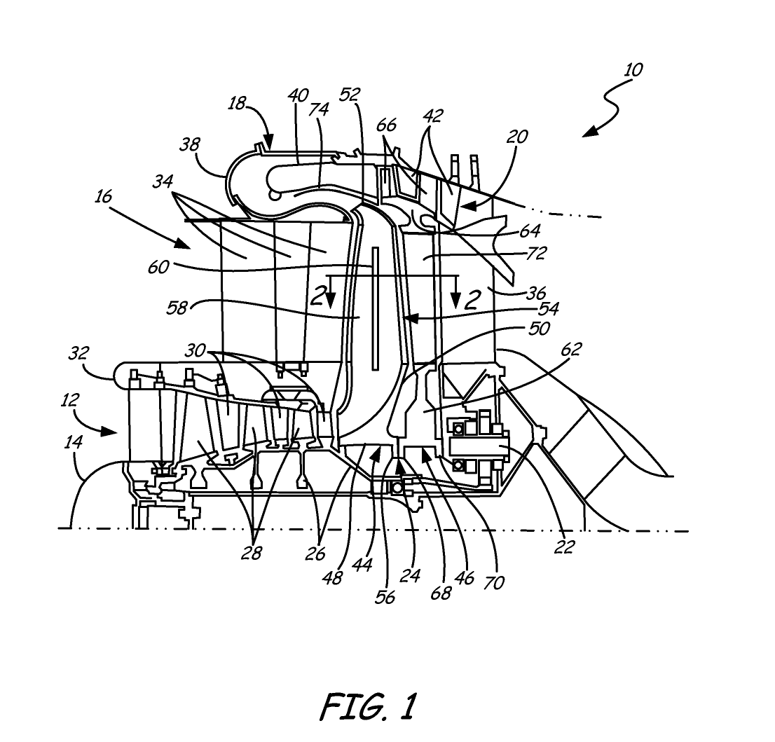

FIG. 1 illustrates a tip turbine engine with an embodiment of a tandem fan-turbine rotor assembly of the present invention. The view in FIG. 1 is a longitudinal sectional view along the engine center line. FIG. 1 shows tip turbine engine 10 including axial compressor 12, nose cone 14, fan section 16, combustor 18, turbine section 20, gearbox 22, and tandem fan-turbine rotor assembly 24. Axial compressor 12 includes compressor rotor 26, compressor blades 28, compressor vanes 30, and splitter 32. Fan section 16 includes fan inlet guide vanes 34 and fan exit guide vanes 36. Combustor 18 includes combustor housing 38 and combustion chamber 40. Turbine section 20 includes tip turbine stators 42. Tandem fan-turbine rotor assembly 24 includes hollow fan blade rotor 44 and solid fan blade rotor 46. Hollow fan blade rotor 44 includes hollow fan blade rotor hub 48, inducer 50, exducer 52, hollow fan blades 54, and tandem connection flange 56. Each hollow fan blade 54 includes internal cavity 58 and internal support rib 60. Solid fan blade rotor 46 includes solid fan blade rotor hub 62, exo-ring 64, tip turbine blades 66, tandem connection flange 68, gearbox connection flange 70, and solid fan blades 72.

As illustrated in FIG. 1, nose cone 14 is positioned along the engine center line (C_{L}) of tip turbine engine 10 at the forward end of axial compressor 12. Tandem fan-turbine rotor assembly 24 is aft of axial compressor 12, with both mounted for rotation about engine center line C_{L}. Fan section 16 is an annular structure radially outward of axial compressor 12, and extending aft beyond tandem fan-turbine rotor assembly 24. Combustor 18 is an annular structure positioned generally radially outward from hollow fan blade rotor 44 and a forward portion of fan section 16. Turbine section 20 is an annular structure located aft of combustor 18 and generally radially outward from solid fan blade rotor 46 and an aft portion of fan section 16. Gearbox 22 connects tandem fan-turbine rotor assembly 24 to axial compressor 12 at compressor rotor 26. Compressor blades 28 extend radially outward from compressor rotor 26 to interact with compressor vanes 30 which are attached to splitter 32. Unlike compressor rotor 26 with attached compressor blades 28, splitter 32 and attached compressor vanes 30 do not rotate. Fan inlet guide vanes 34 extend radially from splitter 32. Fan exit guide vanes 36 extend radially from a non-rotating housing containing gearbox 22.

Hollow fan blade rotor 44 and solid fan blade rotor 46 connect at their tandem connection flanges 56, 68 to form tandem fan-turbine rotor assembly 24. Tandem connection flange 56 is connected to hollow fan blade rotor hub 48. Hollow fan blade rotor hub 48 connects inducer 50 to hollow fan blades 54, which extend radially from hollow fan blade rotor hub 48. Hollow fan blades 54 are connected to exducer 52 at their maximum outward radial extent. Tandem connection flange 68 is connected to solid fan blade rotor hub 62. Solid fan blades 72 extend radially from solid fan blade rotor hub 62. Solid fan blades 72 are connected to exo-ring 64 at their maximum outward radial extent. Tip turbine blades 66 are attached to exo-ring 64 and extend radially outward from exo-ring 64 to interact with tip turbine stators 42 of turbine section 20. Tip turbine stators 42 are attached to a non-rotating support portion of tip turbine engine 10. Tandem fan-turbine rotor assembly 24 connects to gearbox 22 at gearbox connection flange 70.

Combustor housing 38 largely surrounds combustion chamber 40. Combustor 18 connects to turbine section 20 such that combustion gases generated in combustion chamber 40 are directed into turbine section 20.

In operation, splitter 32 divides incoming air between fan section 16 and axial compressor 12. Air entering axial compressor 12 is compressed by the rotation of compressor rotor 26 of axial compressor 12 and the interaction of compressor blades 28 with compressor vanes 30. As compressed air exits axial compressor 12 it is drawn into inducer 50 of hollow fan blade rotor 44 of adjacent rotating tandem fan-turbine rotor assembly 24. Inducer 50 directs the compressed air from an axial direction to a radial direction and into internal cavity 58 within each of hollow fan blades 54. Internal cavity 58 within each of hollow fan blades 54 extends the length of each of hollow fan blades 54. As tandem fan-turbine rotor assembly 24 rotates, the compressed air within internal cavity 58 accelerates radially, further compressing the air. The further compressed air exits hollow fan blades 54 through exducer 52. Exducer 52 directs the further compressed air from the radial direction from hollow fan blades 54 to an axial direction opposite the axial direction of the compressed air entering inducer 50, and into combustor housing 38. In addition, exducer 52 acts as a shroud for hollow fan blades 54, providing structural stability to reduce vibration and twisting of hollow fan blades 54. The further compressed air flows into combustion chamber 40 through multiple openings between combustor housing 38 and combustion chamber 40, where it is mixed with fuel and ignited by a flame to produce combustion gases with a high temperature and a high gas flow velocity. Optionally, exducer 52 may include diffuser elements to slow the further compressed air, additionally increasing its pressure, thereby preventing the compressed air from blowing out the flame in combustion chamber 40. The combustion gases exit combustion chamber 40 into turbine section 20 and impinge tip turbine blades 66 in a series of stages, each stage including at least one tip turbine blade 66 and at least one tip turbine stator 42 (two stages illustrated in FIG. 1). The impingement and expansion of the combustion gases drives the rotation of solid fan blade rotor 46 through the connection of tip turbine blades 66 to exo-ring 64. Exo-ring 64 drives the rotation of attached solid fan blades 72, which in turn drives the rotation of solid fan blade rotor hub 62. Solid fan blade rotor hub 62 drives the rotation of hollow fan blade rotor 44 through the connection of tandem connection flange 68 to tandem connection flange 56, rotating hollow fan blade rotor 44 at the same rate as solid fan blade rotor 46. The rotation of tandem fan-turbine rotor assembly 24 causes hollow fan blades 54 and solid fan blades 72 to draw air into fan section 16 past fan inlet guide vanes 34 and forcibly discharge the fan air past fan exit guide vanes 36 where the fan air mixes with combustion gases exiting turbine section 20 to provide forward engine thrust. Simultaneously, solid fan blade rotor hub 62 drives rotation in gearbox 22 through gearbox connection flange 70. Gearbox 22 drives the rotation of compressor rotor 26 of axial compressor 12.

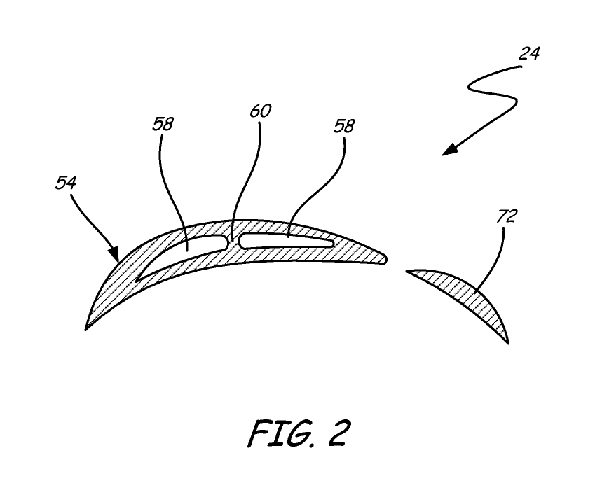

As noted above, hollow fan blade rotor 44 and solid fan blade rotor 46 connect at hollow fan blade rotor hub 48 and solid fan blade rotor hub 62 by way of their respective tandem connection flanges 56, 68 to form tandem fan-turbine rotor assembly 24. This connection also positions solid fan blades 72 with respect to hollow fan blades 54. FIG. 2 is a sectional view of an embodiment of a tandem fan-turbine rotor assembly of the present invention illustrating additional details of hollow fan blades 54, solid fan blades 72, and their relative positions. In this embodiment, there is a one-to-one relationship between each hollow fan blade 54 and solid fan blade 72, that is, there are as many hollow fan blades 54 as solid fan blades 72 for tandem fan-turbine rotor assembly 24 of this embodiment. In addition, the relative position of every hollow fan blade 54 to its tandem solid fan blade 72 is the same throughout tandem fan-turbine rotor assembly 24. As shown in FIG. 2, hollow fan blade 54 is airfoil-shaped and includes internal cavity 58. As described above, it is through internal cavity 58 that compressed air is further compressed by radial acceleration. Hollow fan blade 54 further includes internal support rib 60. As shown in FIG. 1, internal support rib 60 runs nearly the full length of hollow fan blade 54. Internal support rib 60 provides increased structural rigidity for hollow fan blade 54 while reducing the cross-sectional area of internal cavity 58 by only a small amount. Alternatively, internal support rib 60 may be omitted if additional rigidity of hollow fan blade 54 is not necessary. Solid fan blade 72 is also airfoil-shaped.

As shown in FIG. 2, hollow fan blade 54 and solid fan blade 72 are positioned in tandem such that the flow turning capability of hollow fan blade 54 is augmented by solid fan blade 72. In this way, solid fan blade 72 acts as a second fan stage that can provide more flow turning without impairing the performance of hollow fan blade 54.

The present invention splits the functions of a conventional hollow fan-turbine blade rotor between hollow fan blade rotor 44 and solid fan blade rotor 46 of tandem fan-turbine rotor assembly 24. In doing so, the extreme physical loads associated with turbine section 20 of tip turbine engine 10 are removed from hollow fan blade rotor 44. The large torque required to drive axial compressor 12 is limited to solid fan blade rotor 46 and gearbox 22 so hollow fan blade rotor 44 and its hollow fan blades 54 need not be over-built to handle this stress. The tremendous centrifugal stress generated by tip turbine blades 66 is also limited to exo-ring 64, solid fan blades 72, and solid fan blade rotor hub 62. Without the need for an internal cavity, exo-ring 64, solid fan blades 72, and solid fan blade rotor hub 62 can be manufactured with techniques, such as forging, that produce superior strength and durability, rather than techniques necessary for complex, hollow shapes, such as casting, that do not produce the desired strength and durability.

Thermal gradient stress is also greatly reduced with the present invention. Conventional tip turbine engine designs integrate turbine blades into exducers at the tips of the fan blades. Thus, the exducer, which must be manufactured with great precision to handle the tight tolerances associated with maintaining turbine tip clearances, is exposed to a very large temperature gradient caused by the passage of moderately hot compressed air through the interior of the exducer while the exterior of the exducer, where the tip turbine blades are attached, experiences extreme combustion temperatures. This extreme thermal stress combined with the extreme physical loads described above result in a relatively short exducer lifetime. In contrast, in the present invention, because hollow fan blade rotor 44 no longer carries tip turbine blades 66, exducer 52 at the tip of hollow fan blades 54 is able to be isolated from the very hot combustion gas flow by air gap 74 between exducer 52 and combustion chamber 40. The separation create by air gap 74 greatly reduces the temperature gradient across exducer 52, greatly simplifying its design, and extending its lifespan. Exo-ring 64 attached to solid fan blades 72 is exposed to the extreme combustion temperatures in turbine section 20, but exo-ring 64 is a simpler component than an exducer and thus, can more easily be designed and manufactured to handle extreme temperature gradients and mechanical stresses.

In the embodiments described above, exducer 52 is part of tandem fan-turbine rotor assembly 24 and physically attached to hollow fan blades 54. However, it is understood that in an alternative embodiment, exducer 52 is not physically attached to hollow fan blades 54 and is not part of tandem fan-turbine rotor assembly 24, but is attached to combustor 18. In this embodiment, because exducer 52 is separate from hollow fan blades 54, the centrifugal forces on hollow fan blades 54 are reduced. In addition, exducer 52 may be less costly to produce as a non-rotating component. It is also understood that in this embodiment, because exducer 52 is not available to act as a shroud, hollow fan blades 54 should be shrouded to provide structural stability to reduce vibration and twisting.

The present invention is a tandem fan-turbine rotor assembly for use with a tip turbine engine. In contrast to a conventional hollow fan-turbine blade rotor, the tandem fan-turbine rotor assembly has two fan blade rotors configured in tandem: a hollow fan blade rotor and a solid fan blade rotor. By splitting the functions of a conventional hollow fan-turbine blade rotor between two fan blade rotors configured as a tandem fan-turbine rotor assembly, the extreme physical loads and temperature gradients can be limited to the solid fan blade rotor. Without the need for an internal cavity, the solid fan blade rotor can be manufactured with techniques, such as forging, that produce superior strength and durability, rather than techniques necessary for complex, hollow shapes, such as casting, that do not produce the desired strength and durability. In addition, because the hollow fan blade rotor no longer carries the tip turbine blades, an exducer at the tip of the hollow fan blades can be isolated from the very hot combustion gas flow by an air gap. The air gap separation greatly reduces the temperature gradient across the exducer, greatly simplifying its design and extending its lifespan. Finally, by carrying the bulk of the mechanical stress load in the solid fan blade, the lifespan of the hollow fan blades is also greatly extended.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A tandem fan-turbine rotor assembly for a tip turbine engine, the rotor assembly comprising:
a hollow fan blade rotor including:
a first fan blade rotor hub;
a plurality of hollow fan blades attached to the first fan blade rotor hub and extending radially outward from the first fan blade rotor hub; each of the hollow fan blades including an internal cavity extending the length of the hollow fan blade; and
an inducer attached to the first fan blade rotor hub for directing air from an axial compressor to the internal cavities of the plurality of hollow fan blades; and
a solid fan blade rotor including:
a second fan blade rotor hub;
a plurality of solid fan blades attached to the second fan blade rotor hub and extending radially outward from the second fan blade rotor hub;
an exo-ring connecting the plurality of solid fan blades at their maximum outward radial extent; and
a plurality of tip turbine blades connected to the exo-ring and extending radially outward from the exo-ring;
wherein the hollow fan blade rotor and the solid fan blade rotor rigidly attach to each other at the first and second fan blade rotor hubs.

2. The assembly of claim 1, wherein the hollow fan blade rotor further comprises an exducer connecting the plurality of hollow fan blades at a maximum outward radial extent of the hollow fan blades for directing air from the internal cavities of the plurality of hollow fan blades to a combustor.

3. The assembly of claim 2, wherein the exducer is isolated from a flow of combustion gases by an air gap.

4. The assembly of claim 1, wherein the internal cavity within each of the hollow fan blades includes an internal support rib extending at least a portion of the length of the hollow fan blade.

5. The assembly of claim 1, wherein each of the hollow fan blades further includes an exterior that is airfoil-shaped in cross-section.

6. The assembly of claim 1, wherein each of the hollow fan blades is manufactured by casting.

7. The assembly of claim 1, wherein each of the solid fan blades includes an exterior that is airfoil-shaped in cross-section.

8. The assembly of claim 1, wherein each of the solid fan blades is manufactured by forging.

9. The assembly of claim 1, wherein each of the solid fan blades is positioned in tandem with one of the hollow fan blades.

10. A tip turbine engine comprising:
an axial compressor;
a combustor;
a fan section comprising at least one inlet guide vane and at least one exit guide vane;
a turbine section comprising at plurality of tip turbine stators;
a tandem fan-turbine rotor assembly, the assembly comprising:
a hollow fan blade rotor including:
a first fan blade rotor hub;
a plurality of hollow fan blades attached to the first fan blade rotor hub and extending radially outward from the first fan blade rotor hub; each of the hollow fan blades including an internal cavity extending the length of the hollow fan blade; and
an inducer attached to the first fan blade rotor hub for directing air from the axial compressor to the internal cavities of the plurality of hollow fan blades; and
a solid fan blade rotor including:
a second fan blade rotor hub;
a plurality of solid fan blades attached to the second fan blade rotor hub and extending radially outward from the second fan blade rotor hub;
an exo-ring connecting the plurality of solid fan blades at their maximum outward radial extent; and
a plurality of tip turbine blades connected to the exo-ring and extending radially outward from the exo-ring proximate the plurality of tip turbine stators and in fluid communication with combustion gases from the combustor;
wherein the hollow fan blade rotor and the solid fan blade rotor rigidly attach to each other at the first and second fan blade rotor hubs; and
a gearbox connecting the tandem fan-turbine rotor assembly to the axial compressor.

11. The engine of claim 10, wherein the hollow fan blade rotor further comprises an exducer connecting the plurality of hollow fan blades at a maximum outward radial extent of the hollow fan blades for directing air from the internal cavities of the plurality of hollow fan blades to the combustor.

12. The engine of claim 11, wherein the exducer is isolated by an air gap from a flow of combustion gases from the combustor.

13. The engine of claim 10, wherein the internal cavity within each of the hollow fan blades includes an internal support rib extending at least a portion of the length of the hollow fan blade.

14. The engine of claim 10, wherein each of the hollow fan blades further includes an exterior that is airfoil-shaped in cross-section and oriented to produce axial thrust in combination with the at least one inlet guide vane and at least one exit guide vane.

15. The engine of claim 10, wherein each of the hollow fan blades is manufactured by casting.

16. The engine of claim 10, wherein each of the solid fan blades includes an exterior that is airfoil-shaped in cross-section and oriented to produce axial thrust in combination with the at least one inlet guide vane and at least one exit guide vane.

17. The engine of claim 10, wherein each of the solid fan blades is manufactured by forging.

18. The engine of claim 10, wherein each of the solid fan blades is positioned in tandem with one of the hollow fan blades, augmenting the flow turning capability of each of the hollow fan blades to produce axial thrust in combination with the at least one inlet guide vane and at least one exit guide vane.

19. The engine of claim 10, wherein the plurality of tip turbine stators direct combustion gases from the combustor to the plurality of tip turbine blades.

20. A method for operating a tip turbine engine comprising a tandem fan-turbine rotor assembly, the method comprising:
compressing air in an axial direction;
inducing the axially compressed air to flow into a plurality of hollow fan blades;
rotating the hollow fan blades to additionally compress the air in radial direction;
inducing the radially compressed air to flow into a combustor;
igniting the compressed air with fuel in the combustor to produce combustion gases;
directing the combustion gases from the combustor to impinge on tip turbine blades;
rotating solid fan blades attached to the tip turbine blades from the combustion gases impinging on the tip turbine blades; and
driving rotation of the hollow fan blades from the rotation of the solid fan blades.

21. A hollow fan blade rotor for a tandem fan-turbine rotor assembly, the rotor comprising:
a fan blade rotor hub;
a plurality of hollow fan blades attached to the fan blade rotor hub and extending radially outward from the fan blade rotor hub; each of the hollow fan blades including an internal cavity extending the length of the hollow fan blade, wherein the internal cavity includes an internal support rib extending at least a portion of the length of the hollow fan blade; and
an inducer attached to the fan blade rotor hub for directing air from an axial compressor to the internal cavities of the plurality of hollow fan blades.

22. The rotor of claim 21 further comprising:
an exducer connecting the plurality of hollow fan blades at a maximum outward radial extent of the hollow fan blades for directing air from the internal cavities of the plurality of hollow fan blades to a combustor.

23. A solid fan blade rotor for a tandem fan-turbine rotor assembly, the rotor comprising:
a fan blade rotor hub;
a plurality of solid fan blades attached to the fan blade rotor hub and extending radially outward from the fan blade rotor hub;
an exo-ring connecting the plurality of solid fan blades at their maximum outward radial extent; and
a plurality of tip turbine blades connected to the exo-ring and extending radially outward from the exo-ring proximate the plurality of tip turbine stators.
